(19) United States
(12) Patent Application Publication
(10) Pub. No.: US 2014/0239767 A1
(43) Pub. Date: Aug. 28, 2014

(54) ELECTRIC MACHINE WITH V-RISER COMMUTATOR

(71) Applicant: REMY TECHNOLOGIES LLC, Pendleton, IN (US)

(72) Inventors: David Schuster, Indianapolis, IN (US); Gregory L. Howell, Pendleton, IN (US); Eric Babb, Anderson, IN (US); Ronald Dale Gentry, Cicero, IN (US)

(73) Assignee: REMY TECHNOLOGIES LLC, Pendleton, IN (US)

(21) Appl. No.: 13/781,216

(22) Filed: Feb. 28, 2013

(51) Int. Cl. H01R 39/04; H02K 15/00; H02K 13/00

(52) U.S. Cl. CPC H01R 39/04; H02K 13/006; H02K 15/00
USPC 310/236; 29/596

(57) ABSTRACT

A rotor for an electric machine includes a rotor core defining an axis of rotation, a plurality of windings positioned on the rotor core, and a commutator extending from the rotor core. The commutator includes an elongated contact portion and a riser connected to an end of the elongated contact portion. The riser includes a circumferential wall extending radially outward from the end of the elongated contact portion. The circumferential wall includes a V-shaped top portion with a plurality of notches formed in the V-shaped top portion.

### FIELD

This application relates to the field of electric machines, and particularly to commutators for electric machines.

### BACKGROUND

Electric machines for vehicle starter motors typically include an armature including a commutator and brushes. Armature windings are typically connected to the commutator using a riser. A common method of making the connection between the windings and the riser is to use Sil-Fos® or other brazing material to join two winding conductors and the commutator bar together in a welding operation. It has been determined that heat from the welding process may degrade the molding material at locations where the molding material contacts the copper bar of the commutator. In particular, armatures occasionally fail the “Hot Spin Test” because heat from the welding process degrades the molding material at locations where it contacts the copper bars of the commutator. Accordingly, it would be advantageous to provide a commutator bar for an electric machine that significantly reduces the heat required to make a good weld, thus avoiding degradation of the molding material, and providing for solid commutator welds.

### SUMMARY

In accordance with one embodiment of the disclosure, there is provided a rotor for an electric machine. The rotor includes a rotor core defining an axis of rotation, a plurality of windings positioned on the rotor core, and a commutator extending from the rotor core. The commutator includes an elongated contact portion and a riser connected to an end of the elongated contact portion. The riser includes a circumferential wall extending radially outward from the end of the elongated contact portion. The circumferential wall includes a V-shaped top portion with a plurality of notches formed in the V-shaped top portion.

Pursuant to another embodiment of the disclosure, there is provided a commutator for an electric machine comprising an insulative base member and a plurality of conductive segments circularly arranged at equal intervals around the insulative base member. Each of the plurality of conductive segments includes an elongated axial portion and a radial portion. Each radial portion includes a first apex portion, a second apex portion, and a notch formed between the first apex portion and the second apex portion.

In accordance with yet another embodiment of the disclosure, there is provided a method of manufacturing an electric machine. The method includes providing a rotor core including a plurality of armature windings with conductor ends extending from the rotor core, the rotor core defining an axis of rotation. The method further includes inserting at least one of the plurality of conductor ends into one of a plurality of notches in a riser of a commutator, the riser including a circumferential wall extending radially outward from an end of an elongated contact portion, the circumferential wall including a V-shaped top portion with a plurality of notches formed in the V-shaped top portion. In addition, the method includes placing a brazing material on the at least one of the plurality of conductor ends in one of the plurality of notches. The method also includes applying a heat source to melt the brazing material in the slot.

The above described features and advantages, as well as others, will become more readily apparent to those of ordinary skill in the art by reference to the following detailed description and accompanying drawings. While it would be desirable to provide an electric machine with a commutator that provides one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1 shows a partial cross-sectional view of an electric machine including a rotor with a commutator;

FIG. 2 shows a perspective view of the rotor of FIG. 1, including the commutator with a V-shaped riser;

FIG. 3 shows a side view of the commutator of FIG. 2;

FIG. 4 shows an end view of the commutator of FIG. 2;

FIG. 5 shows a half side view and half-cross-sectional view of the commutator of FIG. 2; and

FIG. 6 shows a method of manufacturing an electric machine including the commutator with V-shaped riser of FIG. 2.

### DESCRIPTION

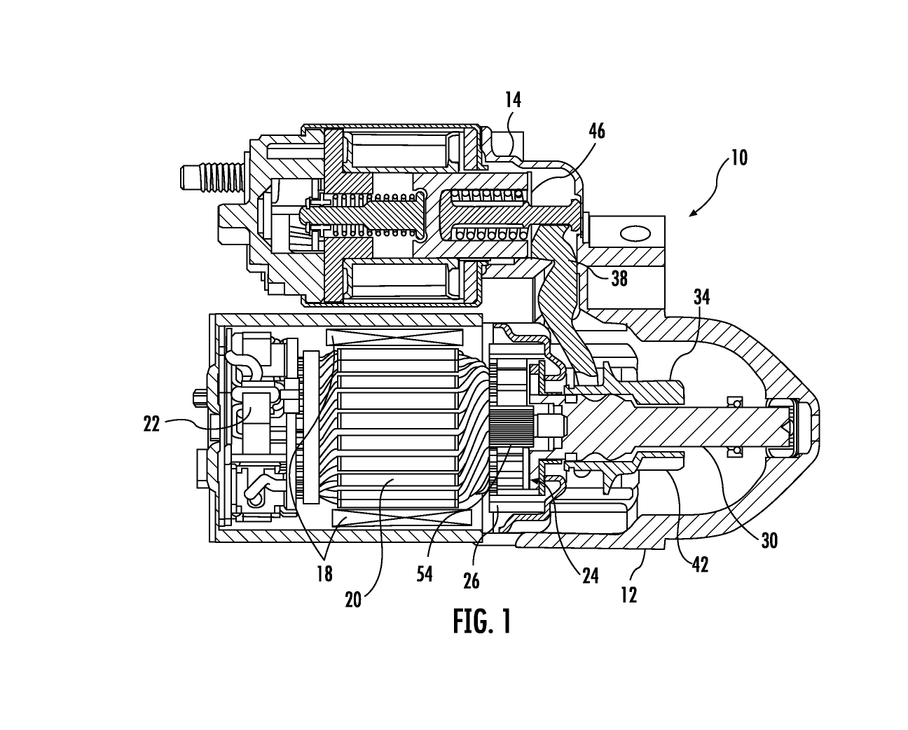

With reference to FIG. 1, an embodiment of an electric machine 10 is shown in the form of a starter motor for a vehicle. The electric machine 10 includes a housing 12, a solenoid 14, an electric motor 16, a gear system 22, a clutch 26, a shaft 30, and a pinion 34, among other components. The housing 12 is typically connected to an engine (not shown), such as an internal combustion engine of an automobile, also not shown) or other vehicle. The electric motor 16 includes a stator 18 and a rotor 20 that provides the armature for the electric machine 10. The stator includes stator windings configured to carry electrical current for the electric machine 10. The rotor 20 is configured to rotate relative to the stator 18 and housing 12 in response to the stator windings and armature windings being supplied with electrical energy. A brush arrangement 22 delivers electrical energy to the armature (i.e., the rotor 20), as will be recognized by those of ordinary skill in the art.

The rotor 20 is coupled to the pinion 34 through the gear system. 24, the clutch 26, and the shaft 30. Accordingly, rotation of the armature 20 results in rotation of the gear system 24 and pinion 34, as will be recognized by those of ordinary skill in the art.

The solenoid 14 is positioned within the housing 12 and connected to a shift lever 38. When the solenoid 14 is electrically energized it causes the lever 38 to move the pinion 34 axially along the shaft 30 until gear teeth 42 on the pinion engage with gear teeth (not shown) on a flywheel of the engine. When electrical energy to the solenoid 14 is removed, a return spring 46 within the solenoid 14 returns the pinion 34 and the lever 38 to their original positions, as will be recognized by those of ordinary skill in the art.

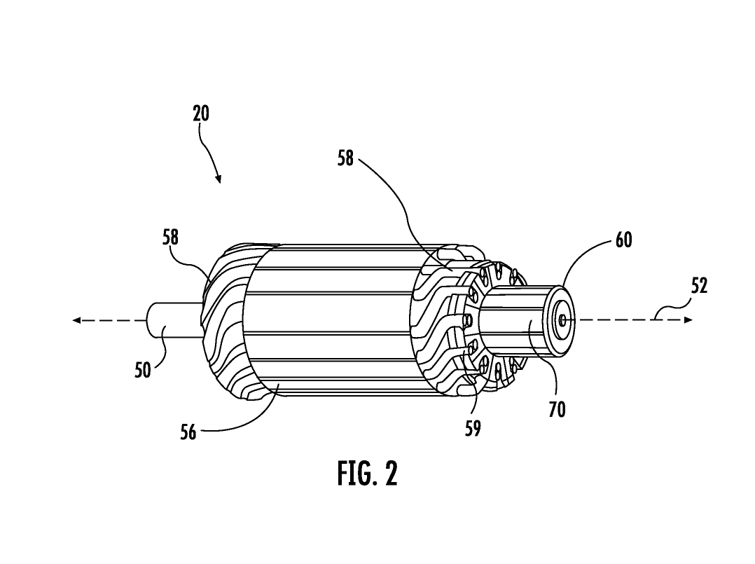

With reference now to FIG. 2, the rotor 20 of the electric machine 10 includes a rotor shaft 50, a rotor core 56, armature windings 58 and a commutator 60. The rotor shaft 50 defines an axis of rotation 52 for the rotor 20. A sun gear 54 (see FIG. 1, not shown in FIG. 2) for the gear system 22 is fixedly secured to the rotor shaft 50. The rotor core 56 is formed from a lamination stack of ferromagnetic material. The armature windings 58 are situated in axial slots formed in the rotor core 56. The armature windings 58 are formed from lengths of copper or other conductors with turn portions provided at one end of the armature core 56 and conductor ends 59 provided at the opposite end of the armature core 56. The conductor ends 59 are connected to the commutator 60.

With reference now to FIGS. 2-4, the commutator 60 of the rotor 20 is shown. The commutator 60 includes an elongated contact portion 62, a riser 64, and a coupling portion 69. The contact portion 62 extends in an axial direction away from the armature windings 58. The contact portion 62 provides a smooth surface configured to slideably engage brushes on the brush arrangement 22. The riser 64 provides a circumferential wall 65 that extends radially outward from a proximate end 63 of the contact portion 62. The circumferential wall 65 provided by the riser 64 includes a V-shaped top portion 68 that provides an apex 78 extending around the riser 64, as explained in further detail below. A plurality of notches 66 extend radially inward from the top portion 68 of the riser 64. The notches 66 are configured to receive and retain the conductor ends 59 of the armature windings 58. The coupling portion 69 is a tapered segment that extends away from the riser 64 and toward the rotor core 56. The coupling portion 69 engages the rotor core 56 and the rotor shaft 52.

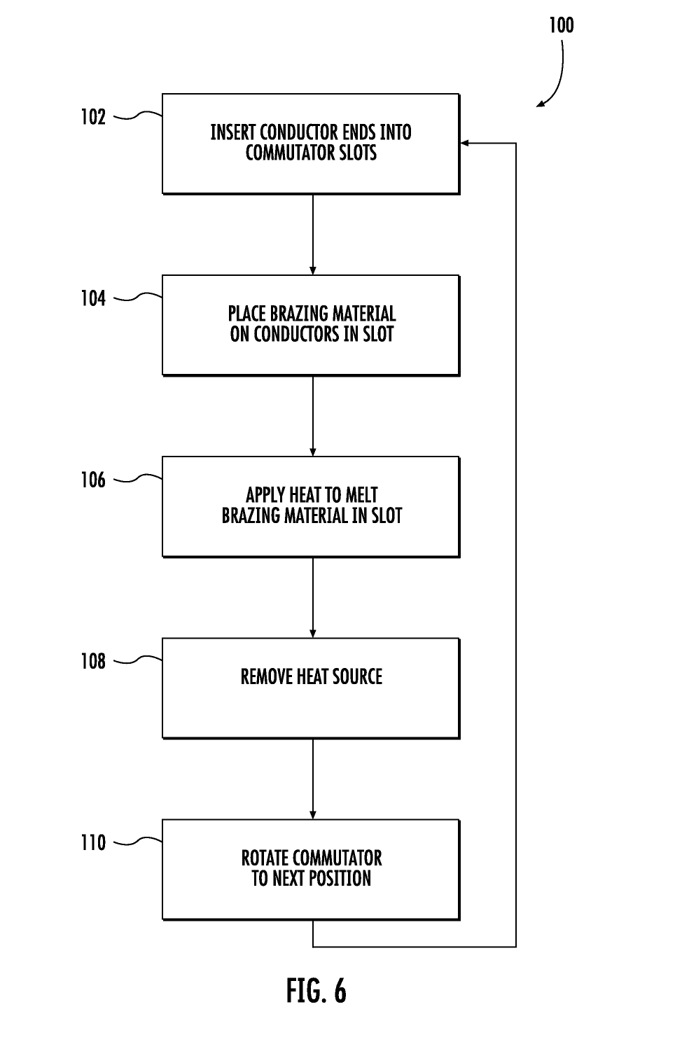

The riser 64 and contact portion 62 of the commutator 60 are formed by a plurality of conductive commutator segments 70 circularly arranged at equal intervals. An insulation strip 80 is formed in each space between two neighboring segments 70. The insulation strips 80 are formed integrally with an insulation base 82 (see FIG. 5). Accordingly, the insulation strips 80 and insulation base 82 may be formed by injection molding or other molding process. The insulation base 82 and insulation strips 80 electrically isolate each conductive segment 70 from the other conductive segments on the commutator 60.

As best illustrated in FIG. 5, each conductive segment 70 of the commutator 60 is comprised of copper or other conductor material and is substantially L-shaped. Each segment 70 includes an axial portion 72 that extends in an axial direction and a radial portion 74 that extends radially outward from the axial portion 72. The radial portion 74 extends perpendicular to the axial portion 72 with the radial portion 74 extending a distance between 2 mm and 5 mm radially outward from the axial portion 72. Of this radial portion 74, about 1 mm to 3 mm is the top portion 68 of the riser 64 extending in the radial direction. Insulative strips 80 are positioned between each segment of the commutator 60. Together, the axial portions 72 of the segments 70 and the associated portions of the insulation strips 80 form the contact portion 62 of the commutator 60. Similarly, the radial portions 74 of the segments 70 and the associated portions of the insulation strips 80 form the riser 64 of the commutator 60.

Each riser portion 74 includes a top portion 76 that is V-shaped. In particular, each top portion 76 includes a sloped proximate surface 90 and a sloped distal surface 92 that extend toward one another and intersect at the apex 78. In the embodiment disclosed herein, the slope on the proximate surface 90 and the distal surface 92 is between thirty and sixty degrees from the axial direction, as shown by angle θ in FIG. 5 (where axis 53 is parallel to axis 52). In at least one embodiment, the slope on the proximate surface 90 and the distal surface 92 is about forty-five degrees. Accordingly, the apex 78 is centrally positioned at the top of the circumferential wall 65. Also, in the embodiment disclosed herein, the sloped portions 90 and 92 each extend between about 3 mm and 5 mm in the axial direction until they meet at the apex. While in the embodiment disclosed herein, the slope on the proximate surface 90 is equal to the slope on the distal surface 92, it will be appreciated that in other embodiments, the slope and the proximate surface 90 and the distal surface 92 may be different.

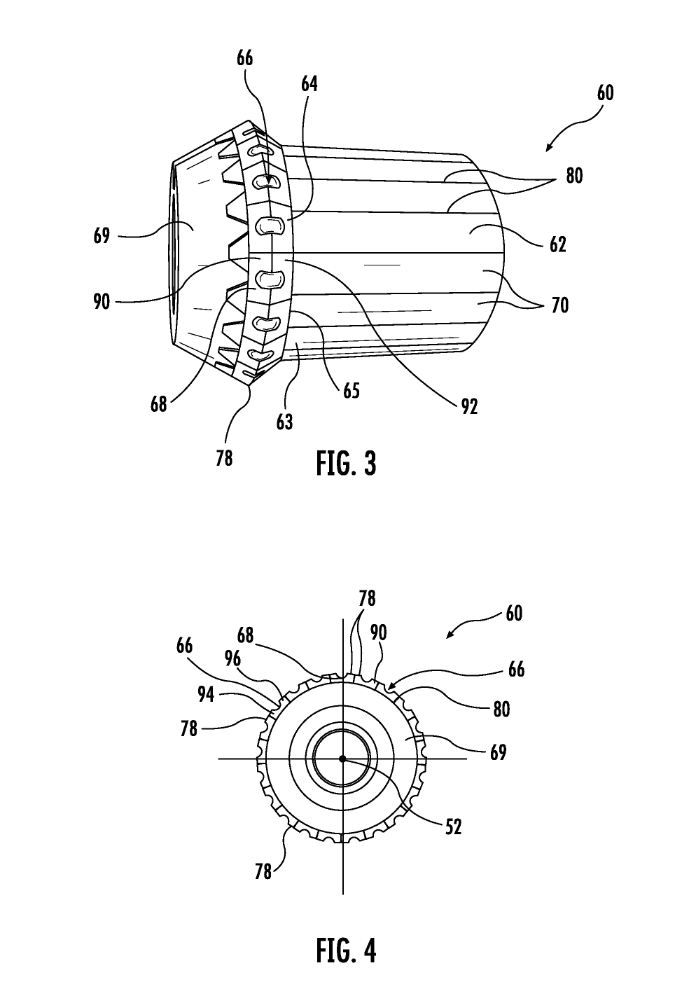

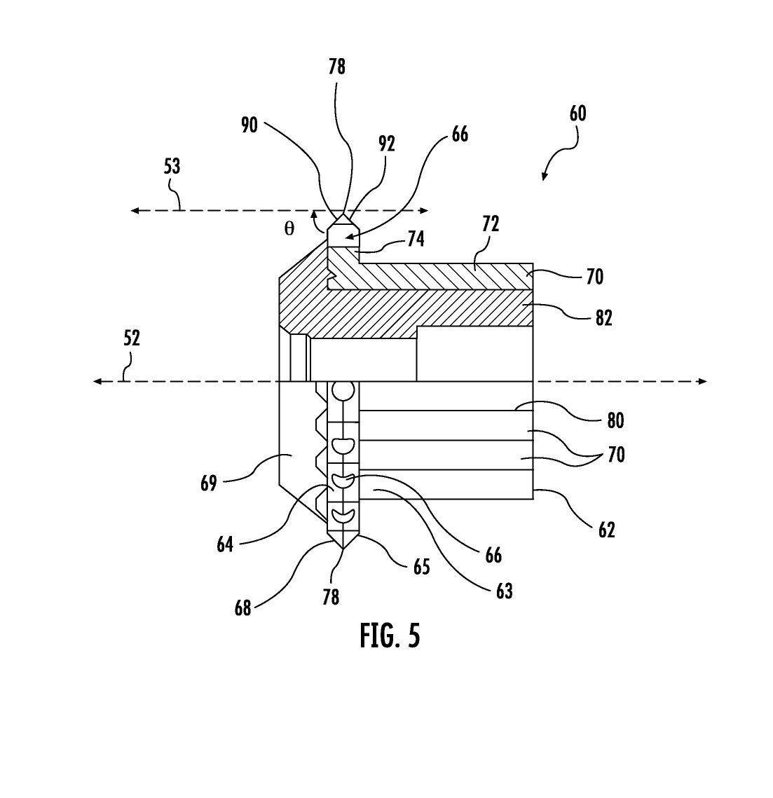

With reference now to FIGS. 3 and 4, the notches 66 separate the radial portion 74 of each segment into a first side 94 and a second side 96 (e.g., a left side and a right side when a segment positioned at an upper position on the commutator 60 is viewed from the proximate end/coupling portion 69 of the commutator). Thus, the apex 78 at the top of the circumferential wall 65 is periodically interrupted by the notches 66 and the joints between adjacent segments (i.e., the joints where the insulation strips 80 are positioned). Because of this, each radial portion 74 may be considered to include a first apex portion (e.g., 94) and a second apex portion (e.g., 96), with a notch 66 positioned between the first apex portion and the second apex portion. The notches 66 are between about 1 mm and 3 mm in width (i.e., in the circumferential direction, and are between 2 mm and 4 mm in length (i.e., in the axial direction). In at least one embodiment, each notch 66 is about 2 mm in width measured at the apex 78 and about 3 mm in length measured along the bottom of the notch 66 in the axial direction.

When viewing the commutator 60 from the end, as shown in FIG. 4, the radial portion 74 of each segment 70 slopes away from the axis 52 until it reaches the apex 78 or one of the notches 66. Accordingly, in the embodiment disclosed herein, the apex 78 of the circumferential wall 65 is positioned to a left side and a right side of each notch 66 and a joint between adjacent conductive segments is positioned adjacent to the apex 78 on each conductive segment 70.

The above-described electric machine 10 provides advantages of increased physical and electrical connections between the conductor ends 59 of the armature 58 and the commutator 60. In particular, the narrowed top (i.e., V-shaped top portion 68) of the riser 64 reduces the contact area between the brazing material and the riser 64. This concentrates the weld heat to the area where it is most needed such that less heat is required to make a solid weld. In at least one embodiment, it has been determined that the geometry of the riser 64 allows for about 41% less power to be used with a one-step weld and about 9% less power for a two-step weld.

Accordingly, the above-described commutator arrangement provides for a method of joining conductors to a commutator, as shown in FIG. 6. The method involves the connection of armature windings to a commutator, where the armature windings are positioned on a rotor core with conductor ends extending from the rotor core. The method begins with the conductor ends 59 being inserted into one of the notches 66 of the commutator 60, as shown in block 102 of FIG. 6. When the conductor ends 59 are inserted into a notch 66 of the commutator 60, the conductor ends 59 are typically positioned above or substantially level with the apex 78 of the riser 64. Next, as shown in block 104, a brazing material is brought into contact with the conductor ends within the notch 66. An exemplary brazing material that may be used is silver/copper/phosphorus (e.g., Sil-Fos®) or other brazing material, including those brazing materials specifically designed for use in copper-to-copper joints. Subsequently, as shown in block 106, heat is applied to the notch 66 with the conductor ends 59 and brazing material positioned therein. The heat may be applied in any of various means, including a welding torch. The heat melts the brazing material allowing it to flow substantially throughout the notch 66. When the heat is removed, as indicated in block 108, the brazing material solidifies, thus bonding the copper conductor ends 59 to the copper riser 64. This bonding of the conductor ends 59 to the riser 64 results in both a physical and electrical connection between the conductor ends 59 and the riser 64 within the notch 66. Next, as indicated in block 110, the core of the commutator and the rotor core are rotated to the next working position, and the process is repeated such that a next set of conductor ends 59 is joined to a next notch 66 of the riser 64. Alternatively, the heat source may be rotated around the commutator and rotor core to sequentially melt brazing material into each of the slots. Advantageously, during the above-described process, the V-shaped top portion 68 of the riser 64 reduces the contact area between the brazing material and the copper riser 64. This concentrates the weld heat to the area where it is most needed and less heat is required to make a solid weld. As a result, heat from the welding process does not significantly degrade the molding material, and a better connection is provided between the conductor ends 59 and the riser 64.

The foregoing detailed description of one or more embodiments of the electric machine with V-shaped commutator riser has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

What is claimed is:

1. A rotor for an electric machine comprising:
a rotor core defining an axis of rotation;
a plurality of windings positioned on the rotor core; and
a commutator extending from the rotor core, the commutator including an elongated contact portion and a riser connected to an end of the elongated contact portion, the riser including a circumferential wall extending radially outward from the end of the elongated contact portion, the circumferential wall including a V-shaped top portion with a plurality of notches formed in the V-shaped top portion.

2. The rotor of claim 1, the commutator including an insulative base member and a plurality of separated conductive segments, each conductive segment including an elongated axial portion and a radial portion at the end of the elongated axial portion, the elongated contact portion of the commutator comprising the elongated axial portions and the riser portion of the commutator comprising the radial portions, each of the plurality of notches formed in a central location on the radial portion of each conductive segment.

3. The rotor of claim 2 wherein an apex of the V-shaped top portion is positioned to a left side and to a right side of each notch and wherein a insulative strip between adjacent conductive segments is positioned adjacent to each apex.

4. The rotor of claim 3 wherein each V-shaped portion includes a sloped proximate surface and a sloped distal surface, wherein the slope on the proximate surface is between thirty and sixty degrees relative to the axis of rotation.

5. The rotor of claim 4 wherein the slope on the proximate surface is about forty-five degrees relative to the axis of rotation.

6. The rotor of claim 3 wherein the sloped proximate surface and the sloped distal surface have substantially the same slope.

7. The rotor of claim 1 wherein each of the notches extends about 3 mm in the axial direction.

8. The rotor of claim 1 wherein the commutator further comprises a coupling portion, the riser positioned between the coupling portion and the elongated contact portion.

9. The rotor of claim 8 wherein the V-shaped top portion includes a sloped proximate surface and a sloped distal surface, the sloped proximate surface closer to the coupling portion than the sloped distal surface, the sloped proximate surface and the sloped proximate surface meeting at an apex on the V-shaped top portion.

10. The rotor of claim 1 further comprising a brush arrangement in contact with the elongated contact portion.

11. A commutator for an electric machine comprising:
an insulative base member; and
a plurality of conductive segments circularly arranged at equal intervals around the insulative base member, each of the plurality of conductive segments including an elongated axial portion and a radial portion, each radial portion including a first apex portion, a second apex portion, and a notch formed between the first apex portion and the second apex portion.

12. The commutator of claim 11 wherein the first apex portion and the second apex portion include a sloped proximate surface and a sloped distal surface, the sloped proximate surface meeting the sloped distal surface at an apex.

13. The commutator of claim 12 wherein the slope on the sloped proximate surface and the sloped distal surface is between thirty and sixty degrees relative to an axis of rotation.

14. The rotor of claim 13 wherein the sloped proximate surface and the sloped distal surface have substantially the same slope.

15. The rotor of claim 11 wherein the notch extends about 3 mm an axial direction.

16. A method of manufacturing an electric machine comprising:
providing a rotor core including a plurality of armature windings with conductor ends extending from the rotor core, the rotor core defining an axis of rotation;
inserting at least one of the plurality of conductor ends into one of a plurality of notches in a riser of a commutator, the riser including a circumferential wall extending radially outward from an end of an elongated contact portion, the circumferential wall including a V-shaped top portion with a plurality of notches formed in the V-shaped top portion;
placing a brazing material on the at least one of the plurality of conductor ends in the one of the plurality of notches; and
applying a heat source to the melt the brazing material in the slot.

17. The method of claim 16 further comprising:
removing the heat source from the brazing material; and
rotating the rotor core and the commutator.

18. The method of claim 16 wherein the brazing material is a silver/copper/phosphorus material.

19. The method of claim 16 wherein an apex of the V-shaped top portion is positioned to a left side and to a right side of each of the plurality of notches and wherein a joint between adjacent conductive segments is positioned adjacent to each apex.

20. The method of claim 16 wherein each of the notches extends about 3 mm in the axial direction.
